(19) United States
(12) Patent Application Publication
(10) Pub. No.: US 2020/0324436 A1
(43) Pub. Date: Oct. 15, 2020

(54) CUTTER AND CUTTING METHOD FOR CONCRETE TEST BLOCK

(71) Applicant: GUANGXI UNIVERSITY, Nanning (CN)

(72) Inventors: LUFENG YANG, Nanning (CN); JIAQI ZHAO, Nanning (CN); KAI YANG, Nanning (CN); YU QIN, Nanning (CN); HANG ZHANG, Nanning (CN); ZHENG CHEN, Nanning (CN); YOUWEN TAN, Nanning (CN); HAIFEI YE, Nanning (CN); RONGZHENG HUANG, Nanning (CN)

(21) Appl. No.: 16/844,994

(22) Filed: Apr. 9, 2020

(30) Foreign Application Priority Data
Apr. 10, 2019 (CN) 201910285792.4

(51) Int. Cl. B28D 1/24; B28D 7/02; B28D 7/04

(52) U.S. Cl. CPC B28D 1/24; B28D 7/04; B28D 7/02

(57) ABSTRACT

A cutter and a cutting method for concrete test blocks, where an upright column is fixed at left-rear end of a base, a support for an electric motor provided at rear end thereof is provided on an upper part of the column, a driving gear is provided at left side of the electric motor, a driven gear is connected with the driving gear via a belt, a control switch is provided at a front end of the support, a grip is provided at right side of the control switch, a transmission shaft is connected to right side of the driven gear, double sawblades are provided at right end of the transmission shaft, a shield is provided above the double sawblades, a water pipe is connected to an upper part of the shield, the clamp is provided at right-front end of the base and the handle is connected to the grip.

### CROSS-REFERENCE TO RELATED APPLICATIONS

This application claims the benefit of priority from Chinese Patent Application No. 201910285792.4, filed on Apr. 10, 2019. The content of the aforementioned application, including any intervening amendments thereto, is incorporated herein by reference in its entirety.

### TECHNICAL FIELD

This application relates to the testing for durability of concrete, and more particularly to a cutter and a cutting method for concrete test blocks.

### BACKGROUND OF THE INVENTION

Generally, in the concrete Rapid Chloride Migration (RCM) test, cylindric concrete test blocks are prepared and then cut to standard test blocks with a thickness of 50 mm. It is required that after cutting, top and bottom surfaces of the standard test blocks are smooth and parallel to each other, and the bottom surfaces are perpendicular to an axis of the cylinder. When a conventional single sawblade concrete cutter of 380 V is used to produce a standard test block, the cutting is required to be performed once respectively at front and back sides of the test block. However, the conventional cutting method has the following defects, for example, (1) a larger error may occur in the thickness of the standard test blocks due to the manual measurement of the cutting distance; (2) when cut by the single sawblade cutter, the test blocks bear forces greatly different at both sides of the clamp, such that the test blocks tend to waggle during the cutting, rendering the bottom surfaces not perpendicular to the cylinder axis; moreover, the two steps of cutting make it difficult to ensure that the top and bottom surfaces of the standard test blocks are completely parallel to each other; (3) the water is supplied manually, such that two workers are needed to cooperate to complete the cutting of the concrete test blocks.

Chinese Patent Application No. 201720164613.8 discloses an efficient concrete cutter, in which a plurality of locating slots are fixed on a base to achieve the multiple cutting of a concrete test block. Chinese Patent Application No. 201711084888.1 also discloses a concrete cutter, in which the concrete to be cut is clamped by moving a clamping piece. These two applications can overcome the above defect (2) in the conventional cutting method, but still fail to eliminate the defects (1) and (3). Chinese Patent Application No. 201610364723.9 discloses a cutter and a cutting method for concretes, where the position of a wire-drawing wheel is adjusted via a stepping motor to achieve the production of various sizes of concrete test blocks. This application can overcome the defects (1) and (2), but fails to overcome the defect (3). Chinese Patent Application No. 201310267565.1 discloses a pitch-controlling device for a double-sawblade cutter, which can overcome the defect (1), but still fails to overcome the defects (2) and (3), since the device is not specially designed for concrete test blocks and is not provided with fixing device for test blocks or automatic water feeder.

### SUMMARY OF THE INVENTION

An object of the invention is to provide a cutter and a cutting method for concrete test blocks to overcome the defects in the prior art, where the cutter is provided with double sawblades, a flange module, a clamp, an electric motor and a two-branched water outlet pipe, which can ensure the thickness error of the cut test blocks to be within ±0.5 mm and realize the one-step forming, achieving the accurate and efficient cutting for test blocks.

The invention adopts the following technical solutions.

The invention provides a cutter for concrete test blocks, comprising: a base, an upright column, an electric motor, a support for the electric motor, a driving gear, a driven gear, a transmission shaft, a grip, a belt, a turntable handle, a clamp, double sawblades, a shield for the double sawblades, a water pipe and a control switch;

wherein the upright column is fixed at a left rear end of the base; the support for the electric motor is provided on an upper part of the upright column; the electric motor is provided at a rear end of the support for the electric motor; the driving gear is provided at a left side of the electric motor; the driven gear is connected with the driving gear via the belt; the control switch is provided at a front end of the support for the electric motor; the grip is provided at a right side of the control switch; the transmission shaft is connected to a right side of the driven gear; the double sawblades are provided at a right end of the transmission shaft; the shield for the double sawblades is provided above the double sawblades; the water pipe is connected to an upper part of the shield for the double sawblades; the clamp is provided at a right front end of the base; the turntable handle is connected to the clamp; the clamp consists of a fixed iron block and a movable iron block; the turntable handle drives the movable iron block to move; a clamping force is formed between the fixed iron block and the movable iron block; and the control switch is provided with an “on” button and an “off” button to control the electric motor.

The double sawblades consist of a first sawblade and a second sawblade, and the first sawblade is connected to the second sawblade via a flange module.

The water pipe consists of a rubber pipe, an iron pipe and a two-branched water outlet pipe, and the rubber pipe is connected with the two-branched water outlet pipe through the iron pipe.

The flange module is a stainless steel module that is detachable and replaceable and has an adjustable length.

The clamp is made of iron, and is detachable and replaceable. The clamp fits the concrete test blocks to be cut, and is shorter than the flange module.

The two-branched water outlet pipe is configured to generate two streams of water which are respectively ejected to inner surfaces of the first and the second sawblades.

The invention further provides a method for cutting concrete test blocks using the cutter, which comprises:

(1) placing the concrete test blocks in the clamp, and rotating the turntable handle to clamp the concrete test blocks;

(2) connecting a three-prong plug to a power at 380 V to let the cutter stand by; connecting the rubber pipe to an external faucet; opening the faucet; pressing the “on” button on the control switch to rotate the double sawblades normally; and pressing the grip to cut the concrete test blocks at a constant speed;

(3) after the cutting is completed, lifting the grip to remove the double sawblades off the test blocks at a constant speed; pressing the “off” button on the control switch; closing the faucet; after the double sawblades stop rotating, rotating the turntable handle to release the test blocks, thus obtaining standard test blocks.

Compared to the prior art, the invention has the following beneficial effects.

The double sawblades, flange module and clamp are employed to overcome the defects in the conventional cutting methods that (1) a larger error may occur in the thickness of the standard test blocks due to the manual measurement of the cutting distance; and (2) when cut by the single sawblade, the test blocks bear forces greatly different at both sides of the clamp, such that the test blocks tend to waggle during the cutting, making the bottom surfaces not perpendicular to the axis of the cylinder, and the two-step cutting makes it difficult to ensure that the top and bottom surfaces of the standard test blocks are completely parallel to each other. The present invention can ensure the thickness error of the standard test blocks to be within ±0.5 mm, and realize the one-step forming. Moreover, the invention can also ensure the top and bottom surfaces of the standard test blocks to be perpendicular to the axis, achieving accurate and efficient cutting for test blocks.

The electric motor and the two-branched water outlet pipe are introduced to solve the defect in the conventional cutting method that the water is supplied manually, such that two workers are needed to cooperate to complete the cutting of the concrete test blocks. In the present invention, one worker is able to complete the whole cutting process, which saves the manual labor and provides a safe and high-efficient operation.

### BRIEF DESCRIPTION OF THE DRAWINGS

FIG. 1 is a schematic diagram of a cutter for concrete test blocks according to the present invention.

FIG. 2 schematically shows double sawblades of the cutter for the concrete test blocks according to the present invention.

FIG. 3 schematically shows a clamp of the cutter for the concrete test blocks according to the present invention.

FIG. 4 schematically shows a control switch of the cutter for the concrete test blocks according to the present invention.

FIG. 5 schematically shows a water pipe of the cutter for the concrete test blocks according to the present invention.

FIGS. 6A-B schematically show thicknesses of the standard test blocks obtained by a conventional cutting method.

FIGS. 7A-B schematically show top and bottom surfaces of the standard test blocks obtained by the conventional cutting method which are not perpendicular to the axis.

FIGS. 8A-B schematically show standard test blocks obtained by a cutting method according to the present invention.

In the drawings, 1-base, 2-upright column, 3-support for electric motor, 4-driving gear, 5-driven gear, 6-transmission shaft, 7-grip, 8-electric motor, 9-belt, 10-turntable handle, 11-clamp, 12-double sawblades, 13-shield for the double sawblades, 14-water pipe, 15-control switch.

### DETAILED DESCRIPTION OF EMBODIMENTS

The invention will be described in detail below with reference to the accompanying drawings and embodiments to make the technical solutions better understood.

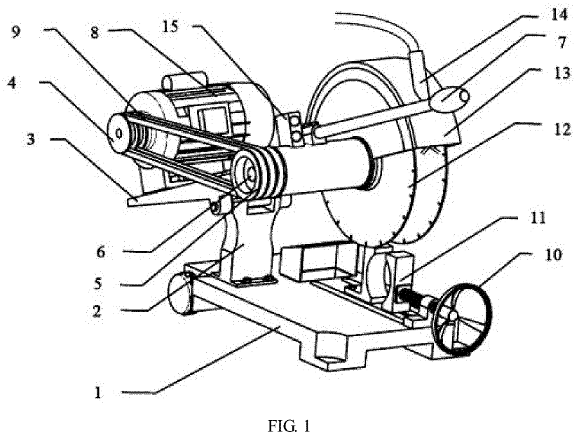

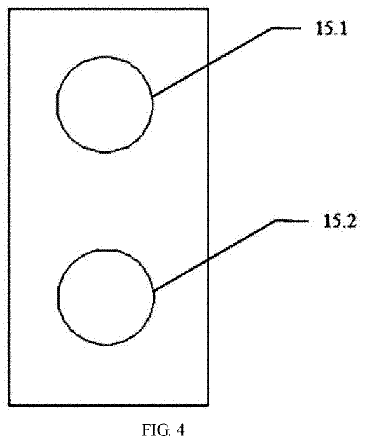

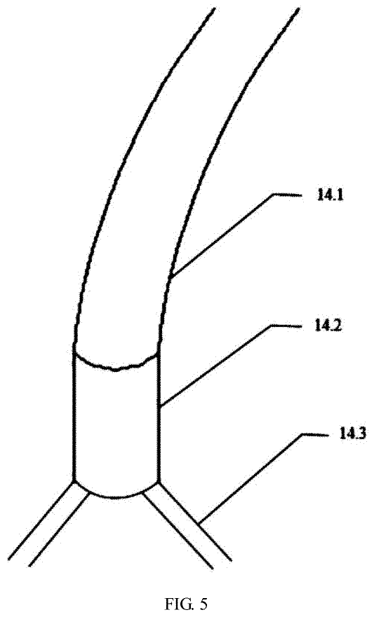

As shown in FIGS. 1-4, the invention provides a cutter for concrete test blocks, which includes a base 1, an upright column 2, a support 3 for an electric motor 8, a driving gear 4, a driven gear 5, a transmission shaft 6, a grip 7, the electric motor 8, a belt 9, a turntable handle 10, a clamp 11, double sawblades 12, a shield 13 for the double sawblades 12, a water pipe 14 and a control switch 15.

The upright column 2 is fixed at a left rear end of the base 1. The support 3 for the electric motor 8 is provided on an upper part of the upright column 2. The electric motor 8 is provided at a rear end of the support 3 for the electric motor 8. The driving gear 4 is provided at a left side of the electric motor 8. The driven gear 5 is connected with the driving gear 4 via the belt 9. The control switch 15 is provided at a front end of the support 3 for the electric motor 8. The grip 7 is provided at a right side of the control switch 15. The transmission shaft 6 is connected to a right side of the driven gear 5. The double sawblades 12 are provided at a right end of the transmission shaft 6. The shield 13 for the double sawblades 12 is provided above the double sawblades 12. The water pipe 14 is connected to an upper part of the shield 13 for the double sawblades 12. The clamp 11 is provided at a right front end of the base 1, and the turntable handle 10 is connected to the clamp 11. The clamp 11 consists of a fixed iron block 11.1 and a movable iron block 11.2, and the turntable handle 10 drives the movable iron block 11.2 to move. A clamping force is formed between the fixed iron block 11.1 and the movable iron block 11.2. The control switch 15is provided with an “on” button 15.1 and an “off” button 15.2 to control the electric motor.

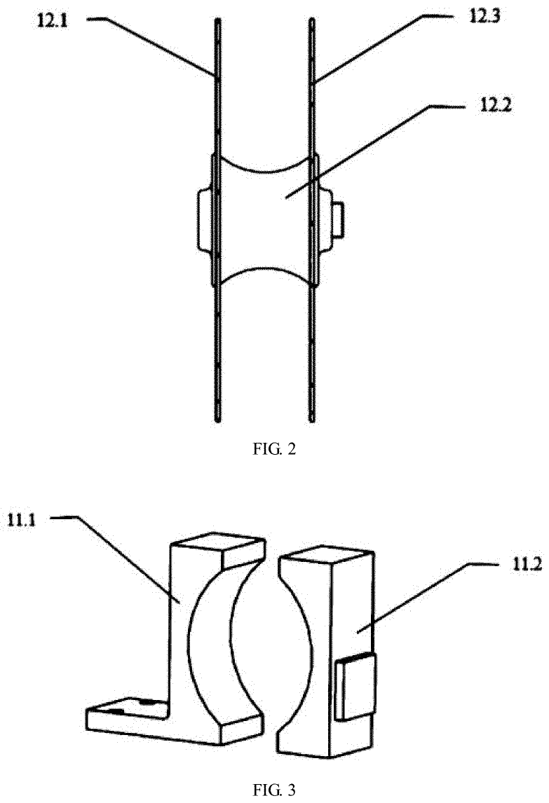

As shown in FIG. 2, the double sawblades 12 consists of a first sawblade 12.1 and a second sawblade 12.3, and the first sawblade 12.1 is connected to the second sawblade 12.3 via a flange module 12.2.

As shown in FIG. 5, the water pipe 14 consists of a rubber pipe 14.1, an iron pipe 14.2 and a two-branched water outlet pipe 14.3, and the rubber pipe 14.1 are connected with the two-branched water outlet pipe 14.3 through the iron pipe 14.2.

The invention further provides a method for cutting concrete test blocks using the cutter, which includes the following steps.

(1) Loading of Concrete Test Blocks

The concrete test blocks are placed in the clamp 11, and the turntable handle 10 is rotated to clamp the concrete test blocks.

(2) Cutting of Concrete Test Blocks

A three-prong plug is connected to a power at 380 V to let the cutter stand by. The rubber pipe 14.1 is connected to an external faucet. The faucet is opened. The “on” button 15.1 on the control switch 15 is pressed to rotate the double sawblades 12 normally. The grip 7 is pressed to cut the concrete test blocks at a constant speed.

(3) Collection of Standard Test Blocks

After the cutting is completed, the grip 7 is lifted to remove the double sawblades 12 off the test blocks at a constant speed. The “off” button 15.2 on the control switch 15 is pressed. The faucet is closed. After the double sawblades 12 stop rotating, the turntable handle 10 is rotated to release the test blocks, thus obtaining standard test blocks.

### Embodiment

This embodiment was intended to verify the validity of the cutter and the cutting method provided herein for concrete test blocks, specifically, 14 cylindrical concrete test blocks (φ 100 mm×100 mm; strength grade: C35-C55) were cut to standard test blocks (φ 100 mm×50 mm).

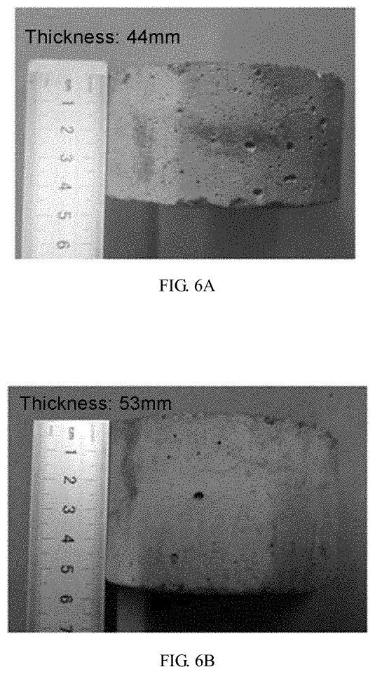

FIGS. 6A-B show the standard test blocks obtained by a conventional cutting method, and it can be seen from the figures that due to the inaccurate measurement of cutting distance, the standard test blocks are too thin or too thick.

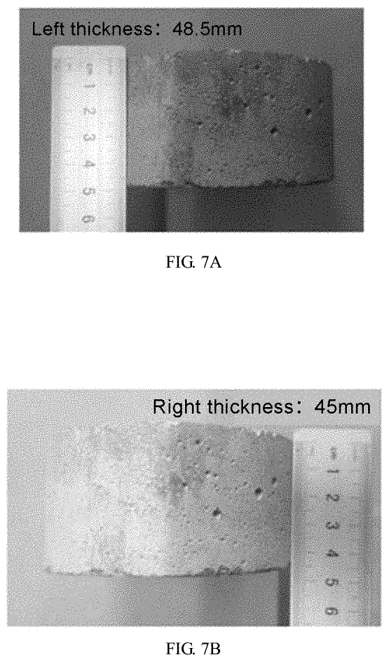

FIGS. 7A-B show the cutting effect of the conventional method for the cylindrical concrete test blocks from another perspective view. It can be seen from the figures that the standard test blocks have different thicknesses at the left and right sides, which indicates that top and bottom surfaces of the standard test blocks are not perpendicular to the axis. This is because when cut by a sawblade, the test blocks bear significantly different forces at both sides of the clamp, so the test blocks are prone to waggling during the cutting.

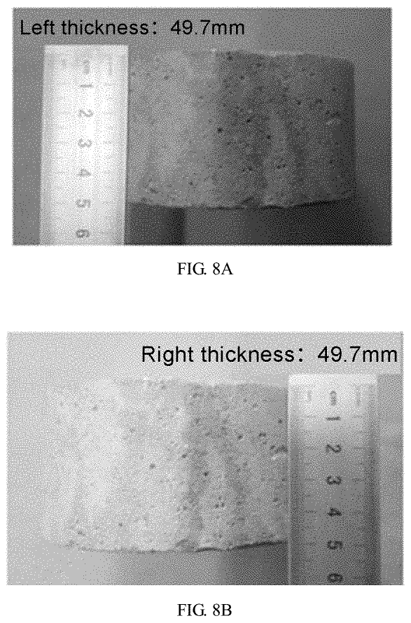

FIGS. 8A-B show the cutting effect of the method provided herein for the cylindrical concrete test blocks. It can be seen from the figures that the top and bottom surfaces of the standard test blocks are parallel to each other, and are perpendicular to the axis. Moreover, the standard test blocks are observed to have uniform thicknesses. It can be deduced based on the above results that the cutting effect of the method provided herein for all of the 14 cylindrical concrete test blocks (φ 100 mm×100 mm; strength grade: C35-C55) is similar to that shown in FIGS. 8A-B. After measurement, the 14 standard test blocks are found to have a thickness of 49.5-50.5 mm, indicating that the cutter and the cutting method of the present invention have high stability and when applied to the cutting of concrete test blocks with different strength grades.

What is claimed is:

1. A cutter for concrete test blocks, comprising: a base, an upright column, an electric motor, a support for the electric motor, a driving gear, a driven gear, a transmission shaft, a grip, a belt, a turntable handle, a clamp, double sawblades, a shield for the double sawblades, a water pipe and a control switch;
wherein the upright column is fixed at a left rear end of the base; the support for the electric motor is provided on an upper part of the upright column; the electric motor is provided at a rear end of the support for the electric motor; the driving gear is provided at a left side of the electric motor; the driven gear is connected with the driving gear via the belt; the control switch is provided at a front end of the support for the electric motor; the grip is provided at a right side of the control switch; the transmission shaft is connected to a right side of the driven gear; the double sawblades are provided at a right end of the transmission shaft; the shield for the double sawblades is provided above the double sawblades; the water pipe is connected to an upper part of the shield for the double sawblades; the clamp is provided at a right front end of the base; the turntable handle is connected to the clamp; the clamp consists of a fixed iron block and a movable iron block; the turntable handle drives the movable iron block to move; a clamping force is formed between the fixed iron block and the movable iron block; and the control switch is provided with an “on” button and an “off” button to control the electric motor.

2. The cutter of claim 1, wherein the double sawblades consist of a first sawblade and a second sawblade, and the first sawblade is connected to the second sawblade via a flange module.

3. The cutter of claim 2, wherein the water pipe consists of a rubber pipe, an iron pipe and a two-branched water outlet pipe, and the rubber pipe are connected with the two-branched water outlet pipe through the iron pipe.

4. The cutter of claim 2, wherein the flange module is a stainless steel module that is detachable and replaceable and has an adjustable length.

5. The cutter of claim 2, wherein the clamp is made of iron, and is detachable and replaceable; and the clamp fits the concrete test blocks to be cut, and is shorter than the flange module.

6. The cutter of claim 3, wherein the two-branched water outlet pipe is configured to generate two streams of water which are ejected to inner surfaces of the first sawblade and the second sawblade, respectively.

7. A method for cutting concrete test blocks using the cutter of claim 1, comprising:
(1) placing the concrete test blocks in the clamp, and rotating the turntable handle to clamp the concrete test blocks;
(2) connecting a three-prong plug to a power at 380 V to let the cutter stand by;
connecting the rubber pipe to an external faucet; opening the faucet; pressing the “on” button on the control switch to rotate the double sawblades normally; and pressing the grip to cut the concrete test blocks at a constant speed;
(3) after the cutting is completed, lifting the grip to remove the double sawblades off the test blocks at a constant speed; pressing the “off” button on the control switch; closing the faucet; after the double sawblades stop rotating, rotating the turntable handle to release the test blocks, thus obtaining standard test blocks.
